(19) United States
(12) Patent Application Publication
(10) Pub. No.: US 2007/0048507 A1
(43) Pub. Date: Mar. 1, 2007

(54) LAMINATED CIRCUIT BOARD

(75) Inventors: Yuuji SUZUKI, Nikkou-city (JP); Yuuki KIKUCHI, Nikkou-city (JP); Satoru ZAMA, Tokyo (JP)

Correspondence Address: GARVEY SMITH NEHRBASS & NORTH, LLC, LAKEWAY 3, SUITE 3290, 3838 NORTH CAUSEWAY BLVD., METAIRIE, LA, 70002, US

(73) Assignees: FURUKAWA CIRCUIT FOIL CO., LTD., Nikkou-city (JP); THE FURUKAWA ELECTRIC CO., LTD., Tokyo (JP)

(21) Appl. No.: 11/496,624

(22) Filed: Aug. 1, 2006

(30) Foreign Application Priority Data
(JP) 2005-222316

(51) Int. Cl. B32B 3/00; B32B 18/00

(52) U.S. Cl. 428/209; 428/210

(57) ABSTRACT

To provide a laminated circuit board, in which a conductive paste including low melting point metal is used, without generating a void and crack at a boundary portion between a copper foil and the conductive paste containing low melting point metal, and having high reliability for connection. The laminated circuit board is formed by forming a roughening treated layer by projections having surface roughnesses of 0.3 to 10 μm and the average amount of deposition of 150 mg/dm² or less on an original foil including a copper foil or copper alloy foil having surface roughness of 0.1 to 5 μm at least on one side to form a surface treated copper foil, providing the conductive paste containing low melting point metal on a roughening treated layer side of surface treated copper foil, and laminating the surface treated copper foil with a resin board.

### BACKGROUND OF THE INVENTION

1. Field of the Invention

The present invention relates to a laminated circuit board (multilayered printed circuit board) provided on both sides thereof with wiring, which are electrically connected by conductive composition such as conductive paste.

2. Description of the Related Art

A conventional laminated circuit board is formed by a through hole plating method, which comproses the steps of laminating a plurality of multilayered circuit board bases, opening a through hole in an insulation layer, plating a surface of inner circumference of the through hole to thereby form a plating layer for electrically connecting layers. Therefore, the laminated circuit board formed by the through hole plating method has an advantage in that circuits in the respective layers are connectable with low and stable electric resistance, while it has disadvantages in that the process is complicated and the steps thereof increases, so cost increases and an application of the laminated circuit board is restricted.

The laminated circuit board formed by through hole plating method also has a disadvantage in that parts are not able to be mounted directly on the through hole and the flexibility of wirings is poor.

To overcome the above disadvantage, in the laminated circuit board by through hole plating method, there is proposed a technique of forming the through hole inclined to a surface thereof so as to avoid positions to be arranged with mounted parts.

In recent years, as an interlayer connection method in place of the through hole plating method, there is utilized a laminated circuit board having an interstitial via hole (IVH) of a through hole with conductive paste filled. The method of producing the laminated circuit board using the conductive paste is simplified more than that in the through hole plating method, thereby achieving a lower cost. As a multilayered printed circuit board in which the conductive paste is used, an ALVIH (Aany Layer Interstitial Via Hole) board manufactured by matsushita electric co., Ltd is known.

Due to recent demand for further shortening the process, etc. however, a method of producing the laminated circuit board by simultaneous press has been developed, and the conductive paste is also used in that production method.

The conductive paste used for electrically connecting layers in the laminated circuit board is mainly made of silver paste and copper paste and contains low melting point metal into the main component for a improvement of the stability and a reduction of production time in the production process, which makes the conductive paste soft at a temperature near to the press temperature in the multilayered circuit board formation and brings it in the state easy to be pressure bonded.

The types and amount of low melting point metal to he added into silver paste and copper paste described above are determined in view of the conductivity and the press temperature in the multilayered circuit board formation.

When the laminated circuit board is formed by press using the conductive paste containing low melting point metal, however, a diffusion layer of copper and low melting point metal may sometimes be formed on a surface of copper foil, and a void or crack may be generated at a boundary portion between the copper foil and the conductive paste, and the problem may sometimes occur that a disconnection is caused between the copper foil and the conductive paste and a connection reliability is deteriorated.

### SUMMARY OF THE INVENTION

An object of the present invention is to provide a laminated circuit board, in which a conductive paste containing low melting point metal is used, without a void at the boundary portion between a copper foil and the conductive paste containing low melting point metal, and having high connection reliability.

To achieve the above object, according to the present invention, provided is a laminated circuit board having: a surface treated copper foil formed with a roughening treated layer on an original foil having a copper foil or copper alloy foil with surface roughness of 0.1 to 5 μm at least on one surface, the roughening treated layer being formed by projections and having surface roughness of 0.3 to 10 μm; and a resin board laminated on the surface treated copper foil, the resin board being provided with conductive paste containing low melting point metal.

Preferably, the surface treated copper foil formed on the original foil is formed by projections having the average amount of deposition of 150 mg/dm² or less and surface roughness of 0.3 to 10 μm.

Preferably, luminosity on one surface of the roughening treated layer is 35 or less.

Preferably, the original foil is an electrodeposited copper foil or electrodeposited copper alloy foil. More preferably, the original foil made of the electrodeposited copper foil has a surface roughness of 2 μm or less at least on one side to be treated and is formed by granular crystals.

Preferably, the roughening treated layer includes 200 to 150,000 number of projections in an area of 100 μm×100 m. Further, a height of projections of roughening treated layer is more preferably 0.3 to 3.0 μm.

According to the present invention, provided is a laminated circuit board, in which the conductive paste containing low melting point metal is used, without a void at the boundary portion between a copper foil and the conductive paste containing low melting point metal, and having high connection reliability.

### DESCRIPTION OF THE PREFERRED EMBODIMENTS

Preferred embodiments according to the present invention will be described in more detail.

In the present invention, a laminated circuit board is formed by depositing projection-shaped roughening particles having specific shape and distribution on an original foil (copper foil or copper alloy foil, hereinafter, referred to simply an original foil if unnecessary to distinguish them) to form a roughening treated payer (roughening particle layer), providing a conductive paste containing low melting point metal on the roughening treated layer to form a surface treated copper foil, laminating the surface treated copper foil with an insulation board to form a laminated board, and laminating a plurality of laminated boards. Note that, the conductive paste provided on the roughening treated layer may be provided over the entire surface of the roughening treated layer or partially at a necessary portion near a through hole.

The surface treated copper foil applied to the present invention is a copper foil having high bonding strength, capable of being processed in fine patterns, and preventing a void from being generated at a boundary portion between the copper foil and the conductive paste containing low melting point metal, when laminated with an insulation board of epoxy resin film, polyimide film, or liquid crystalline (mesomorphic) polymer film or polyetheretherketone based resin film having low variation in dielectric characteristic due to low hygroscopicity and heat resistance of being tolerant to soldering.

Specifically, as the insulation board, a film composition contained with 50% or more of epoxy resin, polyimide resin, or liquid crystalline (mesomorphic) polymer is suitable.

The present inventors researched causes of generating the void at the boundary portion between the copper foil and the conductive paste containing low melting point metal. They found that the void was generated when the low melting point metal was diffused into the roughening treated layer of the surface treated copper foil and the generation of void depended on the amount of diffusion of the low melting point metal and the thickness (depth) of the same diffused into the roughening treated layer. And they investigated whether the void and crack are generated or not, a bondability with insulation board, and a shape of roughening particles, regarding a surface roughness of original foil, the amount of roughening particles deposited on the surface, and a surface roughness of roughened surface to be provided with the conductive paste, thereby achieving the present invention

In the present invention, a laminated circuit board using a surface treated copper foil is provided, the surface copper foil being formed by depositing projections made of roughening particles with the average amount of deposition of 150 mg/dm² in a roughening treatment of a copper foil with surface roughness of 0.1 to 5 μm at least on one surface side of original foil, and having a surface roughness of 0.3 to 10 μm at least on one side to be bonded with a conductive paste, wherein the void and crack do not occur at the boundary portion between the surface treated copper foil and the conductive paste even if the conductive paste containing low melting point metal is used onto the main component of metal.

In the present invention, the original foil is a copper foil formed by electroplating or rolling. The original foil is preferably copper or copper alloy foil having thickness of 1 to 200 μm and surface roughness Rz of 0.1 to 5 μm at least on one side of surface. With copper foil under 1 μm thick, it is difficult to treat the surface. Under the consideration about practical use, for a high frequency printed circuit board, copper foil over 200 μm thick is not realistic.

Concerning the restriction of the surface roughness Rz of 0.1 to 5 μm in original foil, the foil having surface roughness Rz under 0.1 μm is difficult to produce in practice. Even if it can be produced, the production cost would be high and this is impractical. While it may be possible to use the original foil having surface roughness Rz of over 5.0 μm, but if considering the high frequency property and availability of fine patterns, the surface roughness is preferably 5.0 μm or less. The surface roughness of original foil is more preferably 2.0 μm or less. The original foil is demanded to have flexibility because there is a possibility of generating the crack in a step of pressing at high temperature in forming the laminated circuit board using conductive paste if the copper foil lacks flexibility.

A copper foil made of granular crystal is preferably for giving flexibility to the copper foil. Specifically, the size of granular crystal is preferably 0.3 μm or more in average, and the copper foil, in which crystals having size of 1 μm or more occupies a cross section area of 10% or more, is more preferably.

In the present invention, the above original foil is treated on its surface. The surface roughening treatment is to deposit roughening particles on the surface of original foil to thereby roughen and make the surface roughness Rz of 0.3 to 10.0 μm at least on the roughened side. The reason for the restriction like above is because when the surface roughness Rz is under 0.3 μm, peel strength becomes weak and the surface treated copper foil is not satisfactory for use, while, when the surface roughness Rz is over 10.0 μm, the high frequency property is degraded and it is also unsuitable for fine patterning.

With considering the high frequency property and the fine patterning, the surface roughness is preferably 3 μm or less.

As described above, depending on the amount of copper or copper alloy deposited on an original foil by surface roughening treatment in the present embodiment, the low melting point metal contained in conductive paste diffuses into the roughening particles, which may sometimes result in the void or crack depending on the thickness of roughening treated layer and a nature of alloy metal composition of copper and low melting point metal.

For preventing the void or crack generated at the boundary portion between the copper foil and the conductive paste layer, though it depends on types of low melting point metal, the number of copper atoms for roughening particles is preferably four times or less as much as that of the low melting point metal atoms capable of diffusing. Note that, for the conductive paste used in practice, it is not preferable that a lot of low melting point metal increasing electric resistance is added. Therefore, the number of low melting point atoms to be diffused is wanted to be a few.

In terms of the above, in the present invention, the amount of copper or copper alloy to be deposited on the original foil is preferably 1 to 150 mg/dm². When the amount of depositions is under 1 mg/dm², the peel strength becomes weak, so it is not satisfactory as a surface treated copper foil achieving object thereof. While over 150 mg/dm², there exist a large number of low melting point metal atoms capable of diffusing, and it makes an electric resistance of the conductive paste of such content high, therefore it is not preferable.

Note that, as described above, if the number of copper atoms forming the roughening particle layer is four times or less as much as the number of the low melting point metal atoms diffusing into the roughening particle layer, the generation of crack and void is suppressed, therefore void and crack can be suppressed even if the amount of deposition is 150 mg/dm² or more since. Therefore, in the case of ignoring the increase of electric resistance of conductive paste and putting stress on the peel strength, as far as the number of roughening copper atoms is four times or less as much as that of low melting point metal atoms capable of diffusing, the surface treated copper foil is possibly available wherein the crack and void are suppressed.

The conductive paste provided on the surface treated copper foil containing the low melting point metal of 1 to 50% to main component (Ag, Cu) is particularly preferable for a laminated circuit board. The low malting point metal contained in conductive paste is preferably Zn, In, Sn, Pb, Bi, or alloy metal of the same and contains at least one of those metals.

The surface treated copper foil, roughening treated on its surface, in the present embodiment desirably has a luminosity of 35 or less. The luminosity in the present embodiment is defined as luminosity generally used as an index of the surface roughness. As a measuring method, light is irradiated to sample surface and the amount of reflected light is measured so as to be expressed as a luminosity value.

In the present embodiment, the luminosity is measured by a luminosity meter (SM color computer, Model Number SM-4, made by Suga Test Instrument) after stainproof treatment for copper foil to be measured in the range of:

Ni: 0.01 to 0.5 mg/dm²

Zn: 0.01 to 0.5 mg/dm²

Cr: 0.01 to 0.3 mg/dm²

On measuring the surface luminosity of the surface treated copper foil, in case that surface roughness Rz is large or depth between roughening particles is deep, the luminosity tends to be small due to that the amount of reflected light becomes less, and in case of smooth surface, the luminosity tends to be large due to that the amount of reflected light becomes more, To improve the peel strength with insulation board, the luminosity is preferably set 35 or less. That is, when the luminosity is over 35, even if the roughened surface has large surface roughness Rz, the relief shapes are flatter and the surface treated copper foil will not fit well with the insulation board and the peel strength will not be improved.

The surface treated copper foil in the present embodiment is deposited with deposition metal less than the amount for holding enough bonding strength with the insulation resin in roughening treatment to suppress the influence of the crack and void by the conductive paste. Therefore, an optimum roughened shape for improving the bondability with insulation resin is required.

In the present embodiment, for reducing a difference in bondability in the respective areas, regarding the projections formed by the roughening particles, it is preferable that there are 200 to 150,000 number of projections having height within a range of 0.2 to 3.0 μm in an area of 100 μm×100 μm. Note that the height referred here is defined as a distance between the surface of original foil and the top of the projection.

Regarding the height of projections formed on the surface of original foil, when it is under 0.3 μm, the effect of improving the peel strength is not obtained due to a low height, while, when over 3.0 μm, it is not suitable for fine patterning in addition to that the high frequency property decreases. If the number of projections is under 200 in the area of 100 μm×100 μm, it is unsuitable regarding the stability of the bondability, while if it is over 150,000, the distance between the projections becomes narrow and the effect for the bondability is not obtained, therefore it is unsuitable.

Regarding the height of projections, it is checked according to observation photograph by SEM observation of a cross section obtained after the surface treated copper foil is covered by resin and polished. The projections are preferably distributed uniformity in the surface thereof.

The roughening particles forming the projections on the surface treated copper foil composing the composite board material of the present embodiment include Cu or Cu and Mo alloy particles or particles of Cu and at least one element selected from the group of Ni, Co, Fe, Cr, V, and W.

While the desired projections may be obtained from Cu particles or Cu and Mo alloy particles, the projections formed by two or more types of alloy roughening particles made of Cu or Cu and Mo alloy including at least one element selected from the group of Ni, Co, Fe, Cr, V, and W are more effective because they are able to form more uniform particles. Since the roughening particles forming these projections are chemically bonded with the insulation resin, they are considered to improve the peel strength. While depending on the type of the resin, as the particles improving the peel strength due to chemical bonding, Cu—Mo alloy, Cu—Ni alloy, Cu—Co alloy, Cu—Fe alloy, Cu—Cr alloy, Cu—Mo—Ni alloy, Cu—Mo—Cr alloy, Cu—Mo—Co alloy, and Cu—Mo—Fe alloy may be mentioned.

At least one element selected from the group of Mo, Ni, Co, Fe, Cr, V, and W included in the alloy particles for forming the projections is preferably contained in the amount of 0.01 ppm to 20% to the Cu content. It is because in the alloy composition where the content is over 20%, the alloy becomes hard to be dissolved on the etching of the circuit patterns in later step.

Furthermore, for obtaining uniform projections, it is desirable to optimize the types of electroplating solution, the current density, bath temperature, and treatment time in roughening treatment.

The surface formed with the projections is preferably provided with at least one metal plating layer selected from the group of Ni, Ni alloy, Zn, Zn alloy, and Ag for the objects of improving tolerance to particle shedding, tolerance to hydrochloric acid, heat tolerance, and electrical conductivity. In addition, the other surface where the projections are not formed is also preferably provided with at least one metal plating layer of Ni, Ni alloy, Zn, Zn alloy, or Ag for the objects of improving tolerance to hydrochloric acid, heat tolerance, and electric conductivity. In order to achieve these objects, the amount of metal deposition is desirably 0.05 mg/dm² or more and 10 mg/dm² or less.

In particular, with liquid crystalline (mesomorphic) polymer resin, Ni or Ni alloy is effective for increasing the peel strength.

The surface treated copper foil having the above structure is formed with a Cr and/or chromate coating layer and subjected to stainproof treatment, or if necessary, is subjected to a silane coupling treatment or subjected to stainproof treatment and silane coupling treatment.

### EXAMPLES

Below, the present invention will be explained in detail with reference to specific examples, but the present invention is not limited to these examples.

Original Copper Foil 1: Untreated electrodeposited and rolled copper foils (original foils) with thicknesses of 12 μm and matte side roughnesses Rz of 0.86 μm were prepared.

Original Copper Foil 2: Untreated electrodeposited copper foil with thickness of 12 μm and matte side roughness Rz of 1.24 μm was prepared.

Original Copper Foil 3: Untreated electrodeposited copper foil with thickness of 12 μm and matte side roughness Rz of 1.56 μm was prepared.

The original copper foils 1, 2 and 3 were plated (roughening treated) at least once in the order of

Plating Baths 1 and then 2 in the range of plating solutions, bath temperatures, and current conditions of Electroplatings A, B and C described blow. The roughened sides were then plated with Ni (0.3 mg/dm²) and zinc (0.1 mg/dm²) and then subjected to chromate treatment.

### Examples 1 to 7

Electroplating A
Plating Bath 1
Copper sulfate (as Cu metal): 1 to 10 g/dm³
Sulfuric acid: 30 to 100 g/dm³
Ammonium molybdate (as Mo metal): 0.1 to 5.0 g/dm³
Current density: 10 to 60 A/dm²
Current applying time: 1 to 20 sec
Bath temperature: 20 to 60° C.
Plating Bath 2
Copper sulfate (as Cu metal): 20 to 70 g/dm³
Sulfuric acid: 30 to 100 g/dm3
Current density: 5 to 45 A/dm²
Current applying time: 1 to 25 sec
Bath temperature: 20 to 60° C.

Electroplating B
Plating Bath 1
Copper sulfate (as Cu metal): 1 to 50 g/dm³
Nickel sulfate (as Ni metal): 3 to 25 g/dm³
Ammonium metavanadate (as V metal): 0.1 to 15 g/dm³
pH: 1.0 to 4.5
Current density: 10 to 60 A/dm²
Current applying time: 5 to 20 sec
Bath temperature: 20 to 60° C.
Plating Bath 2
Copper sulfate (as Cu metal): 10 to 70 g/dm³
Sulfuric acid: 30 to 120 g/dm³
Current density: 20 to 50 A/dm²
Current applying time: 5 to 25 sec
Bath temperature: 20 to 65° C.

Electroplating C
Plating Bath 1
Copper sulfate (as Cu metal): 1 to 50 g/dm³
Cobalt sulfate (as Co metal): 1 to 50 g/dm³
Ammonium molybdate (as Mo metal): 0.1 to 10 g/dm³
pH: 0.5 to 4.0
Current density: 10 to 60 A/dm²
Current applying time: 5 to 25 sec
Bath temperature: 20 to 60° C.
Plating Bath 2
Copper sulfate (as Cu metal): 10 to 70 g/dm3
Sulfuric acid: 30 to 120 g/dm³
Current density: 5 to 60 A/dm²
Current applying time: 1 to 20 sec
Bath temperature: 20 to 65° C.
Comparative Examples 1 to 7

The original copper foils 1, 2 and 3 were plated (roughening treated) at least once in the order of Plating Baths 3 and then 4 in the range of plating solutions, bath temperatures, and current conditions in Electroplatings D, E and F described blow to obtain a surface shape shown in table 1.

The roughened sides were then plated with Ni (0.3 mg/dm²) and zinc (0.1 mg/dm²) and then subjected to chromate treatment.

Electroplating D
Plating Bath 3
Copper sulfate (as Cu metal): 1 to 10 g/dm³
Sulfuric acid: 30 to 100 g/dm³
Ammonium molybdate (as Mo metal): 0.1 to 5.0 g/dm³
Current density: 10 to 60 A/dm²
Current applying time: 15 to 60 sec
Bath temperature: 20 to 60° C.
Plating Bath 4
Copper sulfate (as Cu metal): 20 to 70 g/dm³
Sulfuric acid: 30 to 120 g/dm3
Current density: 3 A/dm²
Current applying time: 2 min or more (variable with surface roughness)
Bath temperature: 15° C.

Electroplating E
Plating Bath 3
Copper sulfate (as Cu metal): 1 to 50 g/dm³
Nickel sulfate (as Ni metal): 3 to 25 g/dm³
Ammonium metavanadate (as V metal): 0.1 to 15 g/dm³
pH: 1.0 to 4.5
Current density: 10 to 60 A/dm²
Current applying time: 15 to 60 sec
Bath temperature: 20 to 60° C.
Plating Bath 4
Copper sulfate (as Cu metal): 20 to 70 g/dm³
Sulfuric acid: 30 to 120 g/dm³
Current density: 3 A/dm2
Current applying time: 2 min or more (variable with surface roughness)
Bath temperature: 15° C.

Electroplating F
Plating Bath 3
Copper sulfate (as Cu metal): 1 to 50 g/dm3
Cobalt sulfate (as Co metal): 1 to 50 g/dm³
Ammonium molybdate (as Mo metal): 0.1 to 10 g/dm3
pH: 0.5 to 4.0
Current density: 10 to 60 A/dm²
Current applying time: 15 to 60 sec
Bath temperature: 20 to 60° C.
Plating Bath 4
Copper sulfate (as Cu metal): 20 to 70 g/dm³
Sulfuric acid: 30 to 120 g/dm³
Current density: 3 A/dm²
Current applying time: 2 min or more (variable with surface roughness)
Bath temperature: 15° C.

The amount of deposited particles, a surface roughness of roughening treated surface, the number of projections, and luminosity by electroplating of roughening treatment of examples 1 to 7 and comparative examples 1 to 7 are shown in table 1.

Evaluation of Peel Strength of Surface Treated Copper Foil

The surface treated copper foils prepared in examples and comparative examples were laminated with a liquid crystalline (mesomorphic) polymer film (hereinafter, also referred to as a film 1) or polyetheretherketone film (hereinafter, also referred to as a film 2) by the following lamination method, and peel strengths are measured.

Lamination Method of Liquid Crystalline (Mesomorphic) Polymer Film and Surface Treated Copper Foil

The surface treated copper foil was laid over the liquid crystalline (mesomorphine) polymer film 1, pressed at 280° C. with a predetermined pressure for 10 minutes, and cooled to obtain a composite board material.

Lamination Method of Polyetheretherketone Film and Surface Treated Copper Foil

The surface treated copper foil was laid over the polyetheretherketone film 2, pressed at 205° C. with a predetermined pressure for 10 minutes, and cooled to obtain a composite board material.

The peel strengths of the obtained composite board material (copper-clad laminate) formed by the surface treated copper foil and film in the above way were measured. The peel strengths were measured by peeling in 180° direction according to JIS C6471. The results are shown in table 1.

Verification Method of Void Generation in Low Melting Point Metal

The verification method of void generation was performed in the following way. Namely, the roughening treated side was plated with Sn being low melting point metal up to 1.5 μm of thickness, and thermally treated at 320° C. The foil was observed at its cross section and checked with the generation of voids and cracks. The results are shown in table 1. Note that, the number of voids shown in table 1 is the number of voids generated in the vicinity of a boundary portion between roughening particles and original foil in length of 200 μm.

TABLE 1

| | | | | | | No. of projec- | | | | | |
|---|---|---|---|---|---|---|---|---|---|---|---|
| | | | | | | tions having | | | | | |
| | | | | | | height of 0.3 | | Film type and peel | | | |
| | | | | Deposition | Treated | to 3.0 μm in | | strength | | | |
| | | | | amount by | surface | unit area | | | Peel | | |
| | Type of | Electro- | Original | treatment | roughness | (100 μm × | | | strength | No. of void | |
| Sample | copper foil | Plating | foil | (mg/dm²) | Rz (μm) | 100 μm) | Luminosity | Film type | (KN/m) | generation | Cracks |
| Ex. 1 | ED | A | 1 | 75 | 1.25 | 24500 | 24 | LC | 0.35 | 0 | N |
| | (electro- | | | | | | | (liquid | | | |
| | deposited) | | | | | | | crystalline) | | | |
| Ex. 2 | Rolled | B | 1 | 115 | 1.65 | 15400 | 23 | LC | 0.42 | 0 | N |
| Ex. 3 | ED | B | 2 | 115 | 1.97 | 15200 | 21 | LC | 0.45 | 0 | N |
| Ex. 4 | ED | C | 3 | 95 | 2.05 | 31500 | 22 | LC | 0.51 | 0 | N |
| Ex. 5 | ED | A | 1 | 65 | 1.21 | 65800 | 25 | PEEK | 0.31 | 0 | N |
| | | | | | | | | (polyether- | | | |
| | | | | | | | | etherketone) | | | |
| Ex. 6 | ED | B | 2 | 89 | 1.45 | 46500 | 22 | PEEK | 0.39 | 0 | N |
| Ex. 7 | ED | C | 3 | 120 | 2.15 | 13500 | 19 | PEEK | 0.46 | 0 | N |
| Comp. Ex. 1 | ED | D | 1 | 198 | 2.25 | 86 | 41 | LC | 0.35 | 37 | Y |
| Comp. Ex. 2 | Rolled | E | 1 | 256 | 2.57 | 142 | 39 | LC | 0.42 | 46 | Y |
| Comp. Ex. 3 | ED | E | 2 | 246 | 2.78 | 157 | 40 | LC | 0.45 | 54 | Y |
| Comp. Ex. 4 | ED | F | 3 | 216 | 2.65 | 178 | 42 | LC | 0.51 | 34 | Y |
| Comp. Ex. 5 | ED | D | 1 | 178 | 2.15 | 89 | 43 | PEEK | 0.31 | 31 | Y |
| Comp. Ex. 6 | ED | E | 2 | 225 | 2.48 | 98 | 37 | PEEK | 0.39 | 35 | Y |
| Comp. Ex. 7 | ED | F | 3 | 306 | 2.89 | 138 | 35 | PEEK | 0.46 | 62 | Y |

The treated copper foil included in the laminated circuit board in the present invention has the peel strength the same level as a conventional copper foil and a sufficient bonding strength with insulation board while the amount of deposition metal for roughening is less than that in the conventional copper foil to lower the surface roughness, is suitable for fine patterning due to that surface roughening treatment is performed uniformly, and is able to provide laminated circuit board wherein the void and crack generated in the vicinity of the boundary portion between the roughening particles and the original foil due to low melting point metal are suppressed without increase in the electric resistance of the conductive paste containing low melting point metal. Therefore, the surface treated copper foil can be applied to various types of electric equipments and apparatus in various fields.

While the invention has been described with reference to specific embodiments chosen for purpose of illustration, it should be apparent that numerous modifications could be made thereto by those skilled in the art without departing from the basic concept and scope of the invention.

What is claimed is:

1. A laminated circuit board comprising:
a surface treated copper foil formed with a roughening treated layer on an original foil, the roughening treated layer being formed by projections and having surface roughness of 0.3 to 10 μm, the original foil having a copper foil or copper alloy foil with surface roughness of 0.1 to 5 μm at least on one surface, and
a resin board laminated on the surface treated copper foil, the resin board being formed with a through hole, the through hole being buried with conductive paste containing low melting point metal.

2. A laminated circuit board as set forth in claim 1, wherein the roughening treated layer formed on the original foil is formed by projections including the number of copper atoms deposited for roughening of four times or less as much as the number of low melting point metal atoms spreading from the conductive paste containing low melting point metal to the roughening treated layer on the time of pressing, and having surface roughness of 0.3 to 10 μm.

3. A laminated circuit board as set forth in claim 1 or 2, wherein the original foil is an electrodeposited copper foil or electrodeposited copper alloy foil.

4. A laminated circuit board as set forth in claim 3, wherein the original foil made of the electrodeposited copper foil has surface roughness of 2 μm or less at least on one side to be treated and is formed by granular crystals.

5. A laminated circuit board as set forth in any one of claims 1 to 4, wherein luminosity on the surface of the roughening treated layer is 35 or less.

6. A laminated circuit board as set forth in any one of claims 1 to 5, wherein the roughening treated layer includes 200 to 150,000 number of projections having height of 0.3 to 3.0 μm in an area of 100 μm×100 μm.
